(19) United States
(12) Patent Application Publication
(10) Pub. No.: US 2017/0232283 A1
(43) Pub. Date: Aug. 17, 2017

(54) FIRE-FIGHTING APPLIANCE FOR DISTRIBUTING WATER DROPLETS

(71) Applicant: BRAVANN AS, Stavern (NO)

(72) Inventor: Terje Ogngard, Stavern (NO)

(73) Assignee: BRAVANN AS, Stavern (NO)

(21) Appl. No.: 15/503,052

(22) PCT Filed: Aug. 13, 2015
(86) PCT No.: PCT/IB2015/056170

§ 371 Date: Feb. 10, 2017

(30) Foreign Application Priority Data
Aug. 13, 2014 (NO) 20140985

(51) Int. Cl. A62C 31/00; B05B 3/16; A62C 99/00; B05B 3/04; A62C 31/05; A62C 31/24

(52) U.S. Cl. CPC A62C 31/005; A62C 31/05; A62C 31/24; A62C 99/0072; B05B 3/0409; B05B 3/16

(57) ABSTRACT

A fire-fighting appliance for distributing water droplets includes a rotating nozzle unit configured with nozzles distributed about the periphery of the nozzle unit, and a tubular element that is prepared for connection to a source of water for supply of water to the nozzles. Furthermore, the fire-fighting appliance includes a motor that is attached to the tubular element and is driven by the water pressure from the water source. The motor is rotatably connected to the nozzle unit and an adjusting device is provided for controlling the rotational speed of the motor for dispersing water droplets through the nozzles in a pulsating action.

### BACKGROUND

One or more embodiments of the invention relate to a fire-fighting appliance for distributing water droplets.

Fire fighting is basically carried out in the same way as it was 100 years ago, with a handheld high-pressure fire hose being used in many cases to discharge large quantities of water at the scene of the fire. This method of extinguishing a fire requires huge amounts of water, thus necessitating the use of fire engines having substantial tank capacity for the supply of large volumes of water to the scene of the fire. It should also be mentioned that this traditional way of fighting a fire poses a great risk to the life and health of the firefighters, because the use of a fire hose involves the firefighter having to go very close to the fire in order to extinguish it.

Associated with today's fire-fighting methods using water is the huge amounts of water utilised in the fire extinguishing operation are responsible for a large amount of the damage inflicted upon buildings and material damaged in the fire.

The large amounts of water used in conventional fire fighting not only cause substantial damage to the buildings, but it has also been found that supply of water in large amounts has an unsatisfactory fire-extinguishing effect. For fire fighting to be effective, it is essential to obtain an efficient conversion of water into water vapour when the water is applied to hot surfaces. Since a hot surface is only able to vaporise a certain amount of water per time unit, it is necessary that the water not be poured on in large amounts, but that it be metered out so as to allow sufficient evaporation of the applied water from the hot surface before more water is supplied. Water that comes into close contact with a hot object evaporates very slowly. This physical phenomenon is described as the Leidenfrost effect and is explained by the fact that a film of vapour is formed between the water and the hot object that prevents the water from boiling away quickly. This is because the vapour film has poor conductivity and therefore the evaporation of the water takes place very slowly.

It is thus necessary that sufficient time be allowed for evaporation before the reapplication of water to the hot surface, otherwise a limited evaporation effect will be obtained and the water applied will not cause vaporisation, but will simply run away from the surface without giving the desired effect.

Thus, the most effective fire fighting is best achieved if a thin layer or a film of water is applied to the hot surface and that sufficient time for evaporation is allowed before water is applied again. It has been found that this method provides the most effective cooling and displacement of oxygen.

With these operating principles as a basis for obtaining a satisfactory extinction of fire, the traditional use of a fire hose to discharge water in large quantities appears inexpedient. Application of large amounts of water means in fact that the desired efficiency is not achieved because the evaporation effect is low when the water striking the hot surface is not allowed time to evaporate before additional amounts of water are applied.

A need has therefore arisen to replace the traditional fire-fighting method, where it is first and foremost the large amounts of water that smother the fire and cool down the material on fire, with newer and more efficient fire-fighting methods. Recently therefore attempts have been made to develop fire-fighting tools with the object of achieving a fire-fighting technique that is more efficient than the conventional use of a fire hose.

These more recent fire-fighting tools include different types of nozzles that are configured with a plurality of small orifices in order to provide an even outward distribution of water droplets. The nozzles can be attached to the end of a fire hose and the water can be distributed through the small orifices in droplet form. Optionally, the nozzle can be configured as a part of a long rod that is attached to the fire hose so as to enable the fire crew to stand at a distance from the fire whilst carrying out the fire-fighting operation.

Today there are several different types of nozzle units for making the water dispersing properties of the nozzles more efficient. Known nozzle units apply excessively large amounts of water to the scene of the fire. Although the known nozzle units represent an improvement compared with the use of an ordinary fire hose, the nozzle units deliver large amounts of water through the orifices in the form of water mist and the desired evaporation effect is therefore not obtained. The reason for the poor efficiency of these known nozzle units is that the rotation of the units is driven directly by the water pressure and that it is the counter-reaction of the water masses that drives the water delivery. The nozzle units thus in principle work as an ordinary garden sprayer where it is the water pressure that determines water volume delivery and the speed of rotation. A nozzle unit of this kind is highly vulnerable to pressure drops and it has been found that in use it is almost impossible to obtain a pulsating action of the water. The result is that the water is delivered as a continuous water mist and it is difficult to achieve precise control when it is the water pressure that is the only driving force. Either the water pressure is adjusted down and the water delivery and rotation of the nozzle unit is too low, with the result that the water does not have sufficient length of throw, or the speed is too high and the amounts of water delivered are too large. Neither of these cases gives the desired effect where the water is delivered with a long range or reach and in small quantities so that evaporation can take place before the next dosage of water reaches the scene of the fire.

Reference will be made here to examples of such nozzle units as they are described in the patent literature:

AU 2010100246 describes a rotating cylinder or drum with a plurality of orifices. The rotating cylinder is attached to the hosepipe and the pressure from the hosepipe drives the cylinder around such that a spinning motion is obtained and the water is sprayed out at high velocity from the cylinder.

US 20070181712 teaches a fog or mist generating nozzle assembly that is also driven by the pressure in the hose to which it is attached. When the water is ejected from the orifices, a forward-directed swirling effect is generated, and the document describes that the total area of the large number of nozzles corresponds to the cross-sectional area of the water inlet to the nozzle, thereby preventing back pressure in the assembly. However, this construction will result in substantial water consumption because in reality it is an open tube. Since the nozzle area is large it is necessary to supply water under high pressure to obtain sufficient length of throw of the water, and therefore enormous amounts of water are applied. This construction is thus wholly dependent on access to water with high water pressure in order to work in a satisfactory manner. The nozzles are positioned such that a forward-directed wall of water is formed to create a shield for the fire crew and the assembly does not provide 360° cover around its periphery.

In WO 9809685 a nozzle assembly is shown that is configured with many small ports where water is supplied and delivered through the nozzles under high pressure. In this assembly, the fire hose is prevented from having the usual known whipping motions when the hose is used under high pressure.

The know nozzle units as described in the said documents have been found to be unsatisfactory in use. This is because the amounts of water supplied are so large that the water does not have time to evaporate before the next round of water is delivered through the nozzle and lies on top of the existing water/vapour layer already on the surface of the object, and the desired effect is therefore not achieved.

To obtain a nozzle unit having good fire-extinguishing properties and good efficiency, it is thus necessary to deliver as little water as possible, but it must be given a long range, and the result must be maximum evaporation. It is important therefore that the time interval between the dosages of water or the speed of rotation of the nozzle unit is balanced such that optimal conditions are provided for evaporation, thereby making it possible to obtain a high-efficiency nozzle unit.

There is therefore a need for fire-fighting appliances designed to enable a more efficient performance of fire extinction.

### SUMMARY

The fire-fighting appliance according to one or more embodiments of the invention avoids the disadvantages as described above, where a satisfactory cooling effect of the surface of the fire source is obtained in that essentially all the water that strikes the surface is converted into vapour. One or more embodiments of the invention both distribute small water droplets with a good range has and have good control of the amounts of water that are delivered.

These are achieved with one or more embodiments of the invention as disclosed in the independent claims and the subsequent dependent claims.

The fire-fighting appliance for distributing water droplets according to the independent claim comprises a rotating nozzle unit configured with nozzles distributed around the exterior of the unit. Furthermore, the fire-fighting appliance comprises a tubular element designed for connection to a water source for supplying water to the nozzles, and a motor attached to the tubular element. The motor is driven by the water pressure that is supplied from the water source and is rotatably connected to the nozzle unit that distributes water droplets on its rotational motion. The fire-fighting appliance further comprises an adjusting device for controlling the rotational speed of the motor and thus the rotational speed of the nozzle unit for dispersing the water droplets through the nozzles. The rotational speed can be controlled so as to obtain a controlled pulsating action in the distribution of the water droplets such that the water droplets are metered out in time intervals with incorporated interruptions where the water is given the opportunity to evaporate before the next dosage is distributed out. The rotational speed can be adjusted depending on the expected rate of evaporation of the water from the surface of the fire source.

The water pressure is used to drive the motor, but since the fire-fighting appliance also has an adjusting device for controlling the rotational speed of the motor, the rotational speed of the nozzles can be controlled without being directly dependent on the water pressure that is supplied from the water source. The water is transferred from the tubular element and out through the orifices in the nozzle unit, and the water pressure thus gives the water droplets maximum range through the orifices. The use of water pressure as a direct driving force to give the water droplets sufficient kinetic energy, together with the fact that the rotational speed of the nozzle unit is adjustable independent of the water pressure, permits the application of small amounts of water with a long range to the scene of fire and allows evaporation before the next dosage of water is applied to the scene of the fire.

The tubular element and the motor can be supported in a bore in the nozzle unit by bearings such that an essentially pressure-tight annular space is provided between the tubular element and the bore wall. The tubular element can then be configured perforated with openings or gaps so as to allow the water to flow from the tubular element into the annular space and thence to the nozzles where it is given water droplet form at the outlet of the nozzles. The motor is driven by the water pressure and in an embodiment comprises, as the adjusting device, a valve that is arranged in the exhaust outlet of the motor. The rotational speed of the motor can then be controlled by adjusting the size of the passage through the exhaust outlet using the valve.

The adjusting device, whether positioned on the motor or provided in another manner, allows control of the rotational speed of the nozzle unit. The fact that the rotational speed of the nozzle unit is controllable means that situations can be avoided in which the evaporation is inefficient because too much water is supplied to the scene of the fire.

In an embodiment, a part of the motor's exhaust outlet can be configured as an exhaust duct in the nozzle unit. The size of the passage through the exhaust duct is reduced by moving the valve in an inward direction in the exhaust duct, and is increased by moving the valve in an outward direction in the exhaust duct.

The structural composition of the fire-fighting appliance facilitates an adjustment of the rotational speed of the nozzle unit so as to allow sufficient evaporation from the surface of the fire source to be obtained before the surface is again provided with a new film of water droplets that are delivered from the nozzles in the subsequent revolution of the nozzle unit.

It should also be mentioned that during use of the fire-fighting appliance according to one or more embodiments of the invention there is no occurrence of counter forces or recoil effects as can be the case when using a fire hose. The large forces that occur when using fire hoses are a major strain for the fire crew and in some cases the large recoil effects in a fire hose can cause the fireman holding the hose to suffer substantial neck and back injuries.

In addition to reducing the water consumption to a minimum with the fire-fighting appliance according to one or more embodiments of the invention, it should also be mentioned that it is an advantage that air is prevented from being fed to the fire as the fire-fighting appliance can simply be inserted through, for example, a window.

For one or more embodiments of the invention to work as intended, it is thus necessary for the vapour film to have time to evaporate sufficiently before a new round of water droplets is applied, otherwise a limited evaporation effect and a reduced effect of the water supply will be obtained. The fire-fighting appliance according to one or more embodiments of the invention is designed such that a great deal of vapour will be emitted in relation to the water consumption in that water is applied in a thin film on the surface of the fire source.
In one or more embodiments, the size of the water droplets can be relatively small and with the small water droplets in the air, the fire gases are cooled and the oxygen in the air is displaced from the fire.

One or more embodiments of the invention make use of the pulsating effect that is produced on rotation of the nozzle unit and when the water droplets that are distributed are small, a vapour effect will also be obtained from surfaces that are hot enough to convert water into vapour, but that do not yet emit fire gases. Through utilisation of the pulsating effect and the use of a motor for rotation of the nozzle unit, the water consumption will be minimal because small amounts of water are supplied at a time and continuous wetting of all surfaces with water is achieved, at relatively short intervals.

The nozzles can be distributed in different ways and give different nozzle dispersion patterns. In one or more embodiments, the dispersion from the nozzles can have a flat disc shape. The number of nozzles can be varied, but in an embodiment six nozzles are used, and these nozzles can be distributed about the exterior of the nozzle unit such that the dispersion of water droplets appears as spherical when the nozzle unit rotates. This dispersion pattern allows an efficient distribution of the water droplets to be obtained at the scene of the fire. If the fire-fighting appliance in addition is combined with an extendible tubular element such that the fireman can stand some distance away from the scene of the fire when the extinguishing operation is carried out, the conditions will be suitable for an efficient fire extinction. The extendible tubular element can of course also be used together with one or more embodiments of the invention without the nozzles being distributed in a way that gives a spherical dispersion of the water droplets.

It has been found that large water droplets are less effective for fire extinguishing, whilst small water droplets, preferably so small that they form so-called water mist, are considered to be ideal for putting out fires. Small droplets have low specific gravity and thus a limited range, and it may therefore be necessary for the fire crew to stand in close proximity to the scene of the fire in order to achieve an efficient extinction thereof.

With the fire-fighting appliance according to one or more embodiments of the invention, the water pressure in the tubular element is able to give the relatively small droplets formed by the nozzles sufficient kinetic energy and an acceptable range. This arrangement combined with a controlled rotation of the nozzle unit as described above gives a fire-fighting appliance that is durable, easy to use and effective.

In one or more embodiments of the invention, the peripheral portion of the nozzles is configured with irregularities in order to provide turbulence and water mist along the peripheral portion, whilst the outflow of water droplets forms a linear flow in the centre portion of the nozzle orifice. These embodiments of the invention allow a water mist to be produced and at the same time provides water droplets with a relatively good range.

In one or more embodiments of the invention, the nozzle unit can be equipped with nozzles that are replaceable, optionally different types of nozzles can be used in one and the same nozzle unit.

One or more embodiments of the invention will now be explained with reference to an example of one or more embodiments of the invention as shown in the figures, wherein:

### BRIEF DESCRIPTION OF DRAWINGS

FIG. 1 shows a sectional view in the axial direction of one or more embodiments of the fire-fighting appliance.

FIG. 2a shows the fire-fighting appliance in FIG. 1 in use.

FIG. 2b is a front view of the fire-fighting appliance in FIG. 2a.

### DETAILED DESCRIPTION

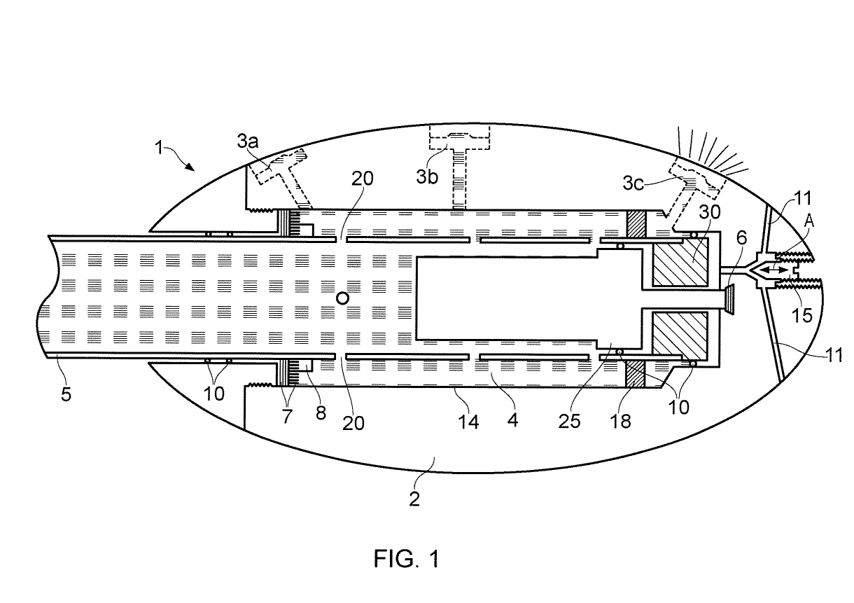

FIG. 1 shows one or more embodiments of a fire-fighting appliance 1 comprising a rotating nozzle unit 2 configured with nozzles 3 extending from a bore formed in the centre portion of the nozzle unit 2. A tubular element 5 is received in the bore such that an annular space 4 is produced between the tubular element 5 and the bore wall 14. An axial bearing 7 that is capable of withstanding the separation pressure from the water pressure holds the tubular element 5 in position and closes the annular space 4 such that the water pressure is kept stable within the annular space 4. A bearing stopper 8 secures the axial bearing 7 in position. A slide bearing 18 positions the tubular element 5 floating in the bore.

The tubular element 5 is connected to a source of water. Water is passed from the tubular element 5 through openings 20 in the tubular element 5 out into the annular space 4 and to the through nozzles 3a, 3b, 3c from which the water flows in droplet form. The water pressure in the tubular element is used to deliver the water droplets with maximum range. The nozzle area is less than the area of the water supply, which means that any drop in pressure in the water supply will have little impact on the fire-fighting appliance

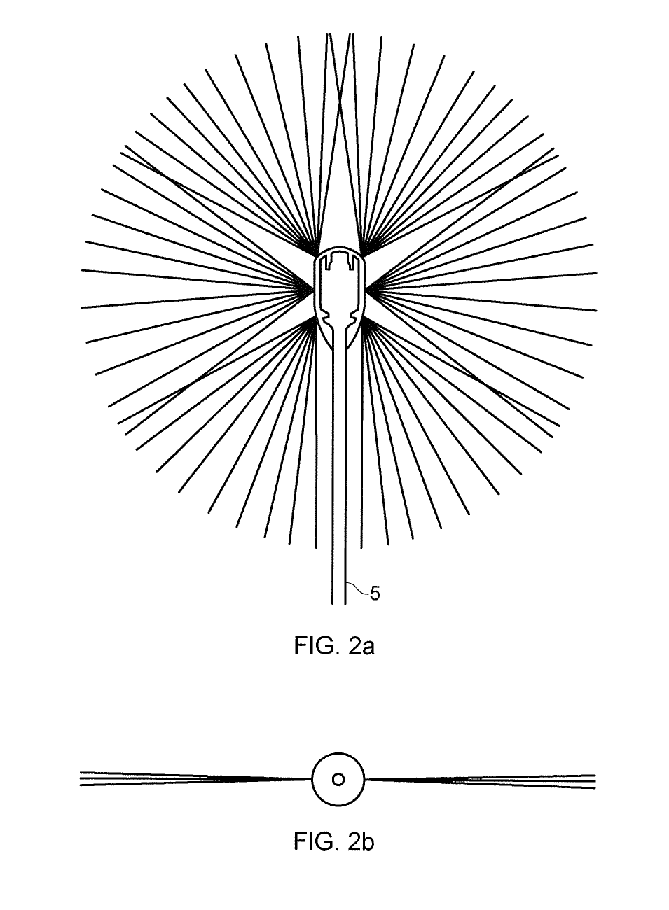

The nozzles 3 are distributed about the exterior of the nozzle unit 2 and two of the sets of nozzles 3a, 3c are oriented with their centre axis angled relative to the centre axis of the nozzle unit 2. When water flows out of the nozzles, this orientation of the nozzles provides a good degree of cover on all sides of the nozzle unit (forwards, backwards and at the centre portion), and an efficient dispersion pattern about the surface of the nozzle unit 2 is formed, as shown in FIG. 2a. In addition, the surfaces are sprayed twice on each revolution of the nozzle unit 2, as is illustrated in FIG. 2a, thereby making efficient use of the water. In the one or more embodiments illustrated in the figures, it can be seen that six nozzles are used, each giving a flat disc-shaped dispersion of the water droplets from the individual nozzle. These may be so-called 60° nozzles that provide water droplets having a good range. As shown in FIG. 2a, two nozzles can be positioned at the front portion of the nozzle unit, two at its centre portion and two at its rear portion. This gives a good degree of cover about the exterior surface of the nozzle unit and the water droplets that are passed out of the nozzles form a wall when the nozzle unit is stationary. When the nozzle unit is rotated about the tubular element 5, the disc-shaped dispersion from the nozzles forms a spherical dispersion pattern and the water droplets are distributed from the nozzle unit in a pulsating action. FIG. 2b is a front view of the dispersion of the water droplet from the nozzle unit.

A motor 25 is connected to the tubular element 5, for example, in that it is fastened to the tubular element 5 with setting screws. The water pressure in the tubular element 5 is utilised as the driving force for the motor, and an adjusting device in the form of a choke valve 15 is used to regulate the speed of the motor. Thus, the motor operates with a conversion ratio between the driving pressure in the water and the output speed of the motor drive shaft 6. The motor drive shaft 6 is fastened to the nozzle unit 2, which thus follows the rotational speed of the drive shaft 6. The nozzle unit 2 is configured with exhaust ducts 11 for discharge of water from the motor. The choke valve 15 is located in the exhaust duct 11 to be able to regulate the size of the passage in the exhaust duct outlet and so determine how much water is to be passed out of the motor 25. The closing motion of the choke valve 15 into the exhaust duct 11 reduces the speed of the motor 25 and the opening motion of the choke valve out of the exhaust outlet increases the speed of the motor. The choke valve 15 can be screwably secured in the exhaust outlet and is thus configured to be screwed inwards in the exhaust duct in order to make the exhaust outlet smaller, and can be screwed out of the exhaust duct in order to make the exhaust outlet larger. The opening and closing motions are illustrated by double arrow A.

Seals 10 in the form of O-rings are disposed between an end piece that is fastened to the nozzle unit 2 and the tubular element 5 to prevent water leakage from the bore 4. The same type of seals 10 are used also to prevent leakage between the exhaust side and the annular space 4. Adjusting devices such as the illustrated choke valve 15 ensure that the rotation of the nozzle unit 2 can be adjusted to a desired speed. Use of the motor gives a more stable rotation of the nozzle unit 2 and the rotational speed can be suitably adjusted to a speed at which the water has time to evaporate between the water dosages. The adjusting device can be configured in alternative ways, for example, the speed of rotation of the power unit can be adjusted by regulating the amount of water/water pressure used as input pressure for the power unit.

FIG. 1 also shows a plug 30 that is secured between the nozzle unit 2 and the tubular element 5. The plug 30 transfers any impacts from the nozzle unit 2 to the tubular element.

The fire-fighting appliance according to one or more embodiments of the invention thus utilises the water pressure in the tubular element for pressure setting of the water droplets that flow out of the nozzles such that they have kinetic energy with a maximum range, whilst the water pressure is used as a driving force for the motor. The rotation of the nozzle unit 2 is adjusted by regulating the adjusting device (the choke valve 15) such that the water has time to evaporate from a surface of a fire source before the next dosage of water droplets is delivered through the nozzles on the same area of the surface of the fire source in the next round of rotation.

The nozzles 3 can be of different design and size in order to vary the size of the droplets that are passed out of the nozzle orifice and the amount of water that is delivered through the nozzles. The number of nozzles can be varied together with their position in the nozzle unit. In the embodiment shown in FIGS. 1 and 2, so-called flat nozzles are used that have an elongate nozzle orifice so that the jet of droplets is thin and broad and exits in a flat fan shape from the individual nozzle orifice.

In the example shown in FIG. 1, the nozzles 3 are shown recessed in the nozzle unit 2 to give better protection against impact etc. during use of the fire-fighting appliance.

The shape of the nozzle orifice can be varied and the nozzles can also be provided in the form of replaceable nozzles, for example, in that they are threaded and screwed into the nozzle unit. It may, for example, be desirable to change to nozzles of small size and set the rotational speed of the power unit at a low level if the fire to be extinguished is in a small space. In one or more embodiments, the circumference of the nozzle orifice is configured with a portion where the material is characterised by irregularities. When the water strikes these irregularities, turbulence occurs in the water and water mist is produced along the nozzle wall, whilst larger water droplets are formed which have a longer range in linear flows generated in the centre portion of the nozzle orifice.

1. A fire-fighting appliance for distributing water droplets, the fire-fighting appliance comprising:
a rotating nozzle unit configured with nozzles distributed around an exterior of the nozzle unit,
a tubular element prepared for connection to a source of water for supplying water to the nozzles, and
a motor attached to the tubular element which is driven by water pressure supplied from the source of water source,
wherein the motor is rotatably connected to the nozzle unit and an adjusting device is provided for controlling a rotational speed of the motor for dispersing the water droplets through the nozzles in a pulsating action as the nozzle unit rotates.

2. The fire-fighting appliance according to claim 1,
wherein the adjusting device comprises a valve that is arranged in an exhaust outlet of the motor, and the rotational speed of the motor is controlled in that a size of a passage through the exhaust outlet is adjusted by the valve.

3. The fire-fighting appliance according to claim 2,
wherein a portion of the motor exhaust outlet is configured as an exhaust duct in the nozzle unit and the size of the passage through the exhaust duct is reduced by moving the valve in an inward direction in the exhaust duct, and is increased by moving the valve in an outward direction in the exhaust duct.

4. The fire-fighting appliance according to claim 1,
wherein the tubular element is supported in a nozzle unit bore by at least one bearing that provides an essentially pressure-tight annular space between the tubular element and a bore wall.

5. The fire-fighting appliance according to claim 4,
wherein the tubular element has openings for outflow of water from the tubular element to the annular space and thence out through the nozzles.

6. The fire-fighting appliance according to claim 1,
wherein the nozzles can be distributed around the exterior of the nozzle unit such that a dispersion of water droplets appears spherical when the nozzle unit rotates.

7. The fire-fighting appliance according to claim 1,
wherein the water droplets are distributed in a flat disc shape from an individual nozzle.

8. The fire-fighting appliance according to claim 1,
wherein the tubular element is extendible.

9. The fire-fighting appliance according to claim 1,
wherein a peripheral portion of the nozzles is configured with irregularities in order to provide turbulence and water mist along the peripheral portion, whilst the outflow of water droplets forms a linear flow in the center portion of the nozzle orifice.

10. The fire-fighting appliance according to claim 1,
wherein the nozzle unit has replaceable nozzles.
